(19) United States
(12) Patent Application Publication
(10) Pub. No.: US 2002/0165749 A1
(43) Pub. Date: Nov. 7, 2002

(54) Method and system for capturing and reporting utilization and allocation of resources and finances

(76) Inventors: Margo R. Northcutt, Richmond, VA (US); Anita G. White, Richmond, VA (US); Travis Andrew Morrell, Donalds, SC (US); Jennifer Ginther, Midlothian, VA (US)

Correspondence Address: Jennifer A. Albert, Esq., Hunton & Williams, Suite 1200, 1900 K Street, N.W., Washington, DC, 20006, US

(21) Appl. No.: 09/849,534

(22) Filed: May 7, 2001

(51) Int. Cl. G06F 17/60

(52) U.S. Cl. 705/8; 705/32

(57) ABSTRACT

A system and method for capturing and reporting utilization and allocation of resources and finances and other relevant data is provided to enable a business entity to better understand where time, money and other resources are spent and to improve communication critical to the business entity. Time entry data may be used for capitalization, inter-company billing and allocations by departments within the business entity, such as a finance department and other departments. In addition, the time entry data may be used to better answer a business leader's questions regarding projects, workloads, results and other areas of interest for the business entity. An authorized business entity may evaluate time entries to determine if more employees and/or resources may be needed for a particular project or business area.

### BACKGROUND OF THE INVENTION

The present invention relates generally to the field of time management, in particular, to a method and system for capturing and reporting utilization and allocation of resources, finances and other relevant data.

Time management and reporting is an important aspect of operations for business entities of various sizes. Traditionally, an employee may complete a time sheet which may provide vague estimates of time spent by the employee on various tasks. Oftentimes, the employee is not accountable for recording how much time the employee spends on a project or an assignment. In some instances, a due date (or a target date) may be applied so that an individual employee's time on a daily, a weekly, a monthly or another basis is not tracked or monitored. In particular, for business entities that do not charge customers on an hourly or other time basis, there is generally little incentive to track time at a detailed level. Therefore, business entities have little understanding of how time and money are spent. As a result, inefficiencies go unnoticed and are not properly addressed.

Current systems for time entry by employees are inflexible to specific needs of a business entity, such as IT needs, for example. In addition, an ability to further analyze time entries once input may also be limited. Oftentimes, the business entity may be required to extract time entries stored in a traditional time tracking system and evaluate time entries through a separate mechanism, such as a spreadsheet, for example.

These and other drawbacks exist with current methods and systems.

### BRIEF SUMMARY OF THE INVENTION

Certain advantages of the invention will be set forth in part in the description which follows, and in part will be understood from the description, or may be learned by practice of the invention. The advantages of the invention may be realized and attained by means of the instrumentalities and combinations particularly pointed out in the appended claims.

This invention, in one aspect, includes a method for capturing and reporting utilization and allocation of resources and finances comprising the steps of identifying at least one of business needs, goals, and requirements; categorizing at least one work task into one or more categories wherein the categories include an applied time category and an unapplied time category; authorizing at least one time entering entity to report time associated with the categories; storing time entry data from the time entering entity; and generating reports for analyzing the time entry data based on one or more user defined factors.

In another aspect, the invention includes a system for capturing and reporting utilization and allocation of resources and finances. The system comprises identifying means for identifying at least one of business needs, goals, and requirements; categorizing means for categorizing at least one work task into one or more categories wherein the categories include an applied time category and an unapplied time category; authorization means for authorizing at least one time entering entity to report time associated with the categories; storing means for storing time entry data from the time entering entity; and generating means for generating reports for analyzing the time entry data based on one or more user defined factors.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a diagram of an overall system for tracking time entries, according to an embodiment of the present invention.

FIG. 2 is a flowchart illustrating the steps performed in a method for tracking time entries, according to an embodiment of the present invention.

FIG. 3 is a flowchart illustrating the steps performed in a method for determining time entry categories, according to an embodiment of the present invention.

FIG. 4 is a diagram of a time entry system, according to an embodiment of the present invention.

FIG. 5 is an example of a main menu for tracking time entries, according to an embodiment of the present invention.

FIG. 6 is an example of a time entry screen shot, according to an embodiment of the present invention.

FIG. 7 is an example of a view posted hours screen shot, according to an embodiment of the present invention.

FIG. 8 is an example of a helper spreadsheet, according to an embodiment of the present invention.

FIG. 9 is a flowchart illustrating the steps performed in a user decision, according to an embodiment of the present invention.

FIG. 10 is an example of a reports module, according to an embodiment of the present invention.

FIG. 11 is an example of a manager report screen shot, according to an embodiment of the present invention.

FIG. 12 is an example of a project report screen shot, according to an embodiment of the present invention.

FIG. 13 is an example of a finance report screen shot, according to an embodiment of the present invention.

FIG. 14 is an example of an application report screen shot, according to an embodiment of the present invention.

### DETAILED DESCRIPTION OF THE INVENTION

The present invention provides a system and method for capturing and reporting utilization and allocation of resources, finances and other relevant data to enable a business entity to better understand where time, money and other resources are spent and to improve communication critical to the business entity. For example, time data may be used for capitalization, inter-company billing and allocations by departments within the business entity, such as a finance department and other departments. Capitalization may apply to internally developed software where a user may have to spend at least a certain amount, such as $400,000, in order to start looking for a capitalization opportunity. That may not necessarily mean that the entire $400,000 is capitalizable. For purchased software, the threshold may be $2500, for example. As for hardware, it may be more cost efficient to lease, rather than purchase. In addition, time data may be used to better answer a business leader's questions regarding projects, workloads, results and other areas of interest for the business entity. For example, through the present invention, an authorized business entity may evaluate time entries to determine if more employees and/or resources may be needed for a particular project or other business sector.

Analysis tools of the present invention may also be used to better and more evenly allocate work among segments of the business entity. For example, the present invention may be used to determine which team may be better equipped to handle a certain project based on various factors, such as an amount of a workload, a level of expertise, a level of resources, etc. Thus, business leaders may better understand business segments at varying levels and detail. The present invention provides process-focused organization and the data, resources, and tools necessary to evaluate organizational effectiveness within the business entity.

A user of a time posting system of the present invention may capture time entries by work requests, solutions or enabling activities. Other categories of time entry may also be implemented, depending on business needs, requirements and other factors. Time data may be synthesized through reporting capabilities and provided to a designated business unit, such as an IT unit, a Finance unit and/or other authorized business units within the business entity. Allocations of time may be differentiated by various criteria, such as a business location, a request group, a work group and/or a magnitude of effort.

The present invention further provides consistent collection of data associated with work requests and time, which are important for proper prioritization, work allocation and process improvement. The present invention provides a web-based system for tracking requests (e.g., feasibility requests, project requests, service requests, IT and other requests) and employee time through a user-friendly, flexible system.

The present invention may be accessed through various modes of communication. For example, the time entry system of the present invention may be accessed via a network, the Internet, a wireless access communication, a satellite, and other methods of communicating information.

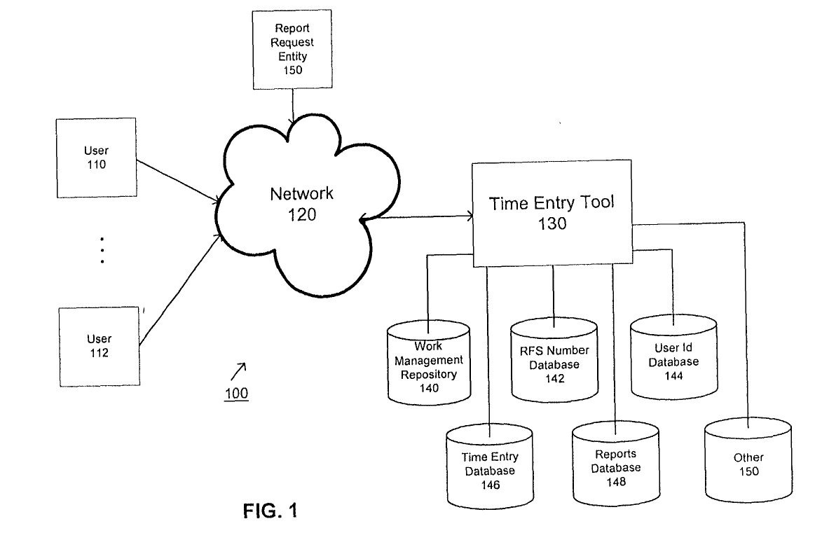

FIG. 1 is a diagram of an overall system 100 for tracking a plurality of time entries, according to an embodiment of the present invention. Users 110 and 112 may access a time entry tool 130 of the present invention through a network 120. Other modes of access to system 100 may be implemented, such as via the Internet, an Intranet, a wireless access device, and other forms of access. Time entry data may be entered, stored, organized, and accessed through the time entry tool 130.

A plurality of databases may be included in the system 100 which may include a work management repository 140, a Request for Service (RFS) database 142, a user ID database 144, a time entry database 146, a reports database 148 and another database 150. The databases of the present invention may be separate databases or may be combined as a single database. Other options may also be implemented. The work management repository 140 may store a plurality of work requests from a plurality of business units within the business entity. The work requests may include a request for services, a work requirements request and other similar types of work requests. The RFS database 142 may store a plurality of identifiers associated with the requests for services and the other work requests. The identifiers may be used by the system 100 to associate entered time with a particular project or task. The user ID database 144 may store a plurality of user identifiers which may be used to verify a user's authorization and access level for accessing the system 100. In addition, a plurality of authorization levels and restrictions that may be applied to a user may be associated with a user ID and stored in the user ID database 144. The time entry database 146 may store a plurality of time entries for a specific user, identified by a user ID. A number of hours, project data, an activity, a work type and/or other data may be stored in the time entry database 146. The reports database 148 may store a plurality of reports generated by the system 100. For example, the reports may be generated and stored in the reports database 148 for further analysis and modification.

An authorized user, such as a report requesting entity 150, may access the time entry tool 130 of the present invention to view generated reports based on various factors and criteria for analysis and other purposes. For example, the generated reports may include a manager report, a project report, a finance report, an application report and other user-defined reports.

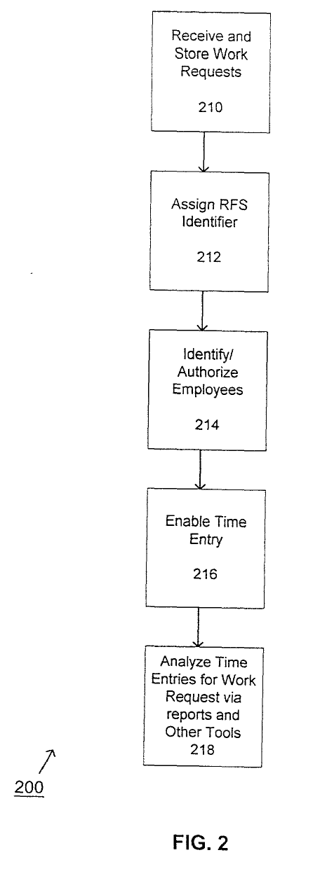

FIG. 2 is a flowchart 200 of steps performed in a method for tracking time entries, according to an embodiment of the present invention. At step 210, the time entry system 100 of the present invention may receive a plurality of work requests from a plurality of business units within the business entity. In addition, the received work requests may be stored in the work management repository 140. At step 212, the system 100 of the present invention may assign an identifier associated with a received work request, which may include a RFS number or another identifier.

At step 214, an authorized user may be identified for access to the system 100 and for assigning time to perform the tasks identified in the particular received work request. One or more access restrictions may be utilized to define a level of permitted access to the system 100 for any particular user. Such access restrictions may include a plurality of varying levels of access authorization, a plurality of authorized individuals and other similar restrictions. For example, a user may have authorization to enter time into the system 100 for a particular project, a group of projects, one or more RFS identifiers, an IT team, and other defined scopes of tasks. The access restrictions may be used to identify who has authority to enter time for a particular task. The authorized users who may be permitted access to the system 100 may include a plurality of full time employees, a plurality of part time employees, a plurality of contractors, a plurality of temporary employees, a plurality of external business entities, a plurality of employees from an associated business entity (e.g., a subsidiary, etc.) and other time entering entities. For example, a high security project may restrict authorization for access to the system 100 to a select group of employees and other associates.

At step 216, the system 100 may enable time to be entered for work performed for the particular received work request. At step 218, the time entries entered for the particular received work request (and/or other tasks) may be analyzed via a plurality of reports and other tools available through the present invention.

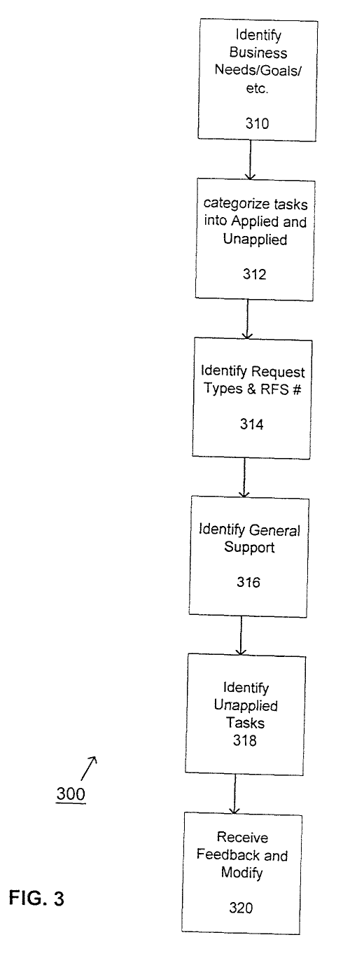

FIG. 3 is a flowchart illustrating the steps performed in a method for determining time entry categories, according to an embodiment of the present invention. At step 310, a plurality of needs, goals, requirements and other aspects of the business entity may be identified. At step 312, a plurality of work tasks may be categorized into an applied time category and an unapplied time category. Depending on the various identified needs, different and/or additional categories for work tasks may be identified as well. At step 314, a plurality of work request types and associated RFS numbers (or other identifiers) may be identified. At step 316, a plurality of general support tasks may be identified, which may not have an associated RFS number. The general support tasks may include a plurality of solutions, enablers and other tasks, depending on the business entity. At step 318, a plurality of unapplied tasks may be identified. The identified unapplied tasks may enable employees to account for time spent out of the office or on administrative tasks, etc. At step 320, feedback regarding time entry categories and other aspects of resource allocation may be analyzed. In addition, modifications to time entries may be made based on the feedback and other changing business needs.

As discussed above, time may be captured or tracked through various categories, such as the applied time category or the unapplied time category. The applied time category may include time entries related to time spent on work with a specific business benefit. The applied time category may include time spent on feasibility requests, project requests, service requests, general support and other categories of work requests. The unapplied time category may also include time taken for vacations, holidays, personal leave, administrative functions, etc.

The time tracking categories may also include categories for time entries that need an associated RFS number and those that do not need an associated RFS number. Time entries that request (or require) an associated RFS number may be linked to a specific business unit and/or solution. A time entry may have an associated identifier that may link the time entry for work to an applicable business and solution (application or infrastructure component). The work management repository 140 may store the work requests for various types of work (e.g., feasibility, project, service, etc.). Depending on the type of business area and other needs of a business entity, different categories of time entry may be implemented, in accordance with the present invention.

Each work request may receive an identifier, such as a RFS number. Other identifiers may be implemented, however. As a result, the work accounted for may be linked to the requesting business unit or other entity. An associated RFS number (or other identifier) allows the time entries to be linked to the business unit that made the work request. Also, the requesting business unit responsible for ensuring that the work request is completed may also be identified and recorded.

Some time entries may not have an associated RFS number as there are some tasks that cannot be linked to a specific business unit and/or solution. These time entries may be linked to an enabling function (e.g., an IT function) that may be performed during the work. For example, business travel and meeting time may be accounted for with a work request, a solution or an enabling function, as applicable. Similarly, training may be accounted for with a work request, a solution or an enabling function, as applicable. In another example, general training that cannot be tied to a specific RFS or a specific solution may be charged to an Enabler/People Engine enabling function.

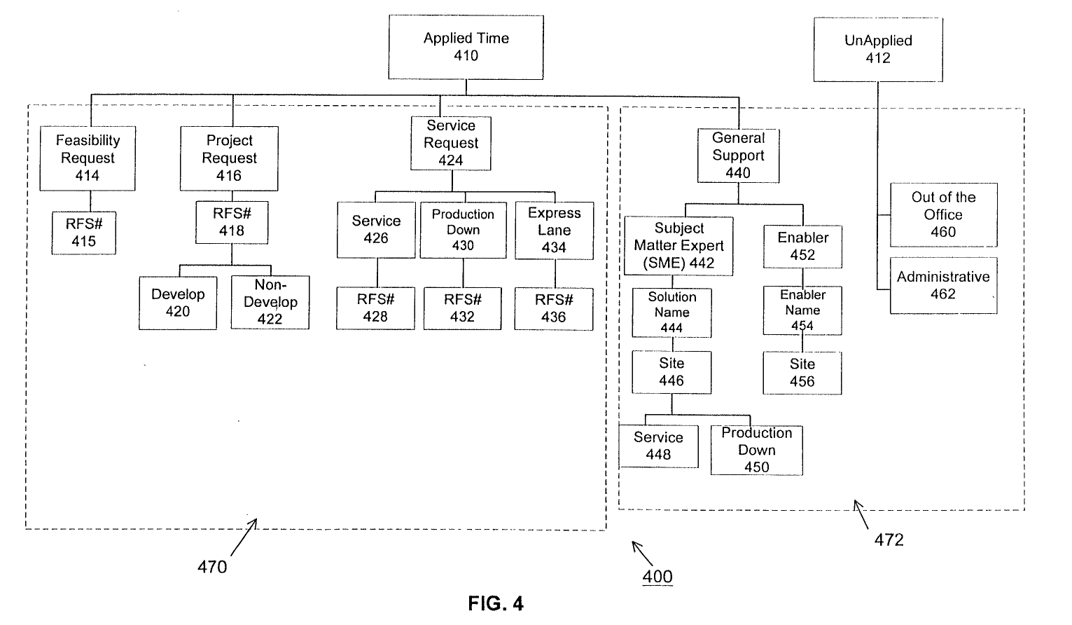

FIG. 4 is a diagram of a time entry system 400, according to an embodiment of the present invention. A plurality of time entries may be categorized into an applied time category 410 (e.g., for a specific business benefit or purpose) or an unapplied time category 412. Other categories may also be implemented. Within the applied time category 410, there may be time entries that have an associated RFS number (or other identifier), as indicated by a box 470. For example, a time entry relating to a work request may be a time entry relating to a feasibility request 414, a project request 416, or a service request 424. Other types of work requests may also be included.

The Feasibility Request 414 may encompass work that may become a project or a service request, but which may require continued research and cost benefit analysis to be performed in order to make a determination. An associated RFS number 415 may be identified with a feasibility request 414, as illustrated. Time may be charged under the Feasibility Request 414 until an initiate phase has been completed and a new RFS number for the project or service request has been created. In addition, when a request for service is submitted for a feasibility study, time may be entered in as a feasibility request.

The Project Request 416 may encompass work that has been categorized as a project request when an RFS has been submitted. Upon selecting an RFS number 418, the system 400 of the present invention may determine if the RFS is one that is capitalizable or not, based on a flag or another indicator. If the RFS is not capitalizable, time spent on development or non-development may be distinguished, rather than phase of work. For example, capitalizable development time may be depreciated over a certain number of years rather than expensed for the current year.

A Development category 420 may encompass work that has been categorized as a project request when the RFS was submitted. If the system 400 determines that the RFS is capitalizable, time related to development may be entered under the development category 420. For a development project, the time entries may include time spent on designing, building, testing and implementation, for example. Other examples may include installing hardware that may be used by an application as well as building and/or obtaining data conversion tools.

A Non-Development category 422 may encompass work that has been categorized as a project request when the RFS was submitted. For a non-development project, time entries may include time spent on feasibility, initiation, and closing, for example. Other examples, may include time spent on feasibility studies, evaluation of alternatives, manual data conversion and process engineering.

A Service Request category 424 may include entries relating to work associated with requests for service 426, production down 430, and express lane 434. Other types of service requests may be implemented as well. Production down may include time and/or efforts spent to address software (and/or hardware) changes, malfunctions, technical difficulties and other reasons for temporarily halting production. Express lane may include short term work (e.g., less than 4 hours effort). Each application team may define what each team may consider to be a short term work. Different teams may have different definitions of what a short term work may encompass. Express lane addresses work that may take more time to discuss in a prioritization meeting, for example, than it would be to simply do the work.

A Service category 426 may be associated with a RFS number 428. The Service category 426 may include changes to existing system functionality due to changing business needs. An example may include the need for capability to interface online order entry with existing applications.

A Production Down category 430 may be associated with a RFS number 432. The Production Down category may include work done on a service request that may be linked to a production down situation. For example, computer systems may need to be in a production down mode when the business entity is in the process of bringing new software for the computer systems into production.

The Express Lane category 434 may be associated with a RFS number 436. Express Lane category 434 may include short term work (e.g., less than 4 hours effort). Each application team may define what each team may consider to be a short term work. In another example, Express Lane category 434 may include work requests with an immediate deadline. Other examples may include work requests that may require immediate attention, feedback or an initial or other response.

The Applied Time category 410 may also include time that may not have an associated RFS identifier. Such time may be categorized into a general support category 440. The general support category 440 may further include a subject matter expert category 442, an enabler category 452 and other categories. Time that does not have an associated RFS number, which may include applied and unapplied time, may be indicated by box 472.

Under the subject matter expert category 442, an associated solution may be identified in a solution name category 444, which may further be associated with a site 446. The solution names may include a service solution 448 or a production down solution 450. Other subcategories and breakdowns may be implemented as well. The service solution 448 may include time spent sharing knowledge where a specific RFS number or function is not identified, but may be linked to a specific solution (e.g., application or infrastructure component). The production down solution 450 may include time spent on fixing problems in a production down (or other) situation where such a task does not have a specific RFS number, but may be linked to a specific solution (e.g., application or infrastructure component).

The solution names may also include a business support application solution, a channel application solution, a servicing application solution, a sales reporting solution, a sourcing solution, and a valuations solution, for example. Time spent performing tasks relating to one or more of a plurality of enabling functions which may be reported in the enabler category 452 may include a change management function, a contract management function, a database administration function, a development methods function, a due diligence function, an e-technology function, a finance and asset management function, a help desk and desktop services function, a network management function, a quality methodologies function, a quality assurance function, a security recovery function, a work management function and other functions.

Under the general support category 440, time spent performing tasks relating to enabling functions which may be reported in the enabler category 452 may include time spent on teaching, coaching, learning, facilitating, development or using an enabling function where an RFS number or specific solution may not be identified. An enabler function name 454 (or other identifier) may be input as well as a site 456.

The Unapplied Time category 412 may include time entries related to out of office time 460, administrative time 462 and other categories of unapplied time. The out of office time 460 may include time associated with vacation, illness, personal days, holidays, jury duty, disability, inclement weather and other similar circumstances. The administrative time 462 may include time spent on activities that are not linked to a specific RFS number, such as email, office moves, team meetings, and other similar activities.

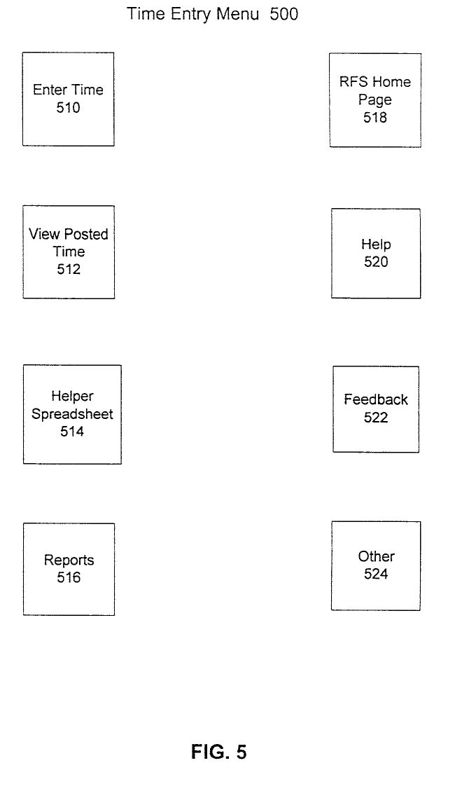

FIG. 5 is an example of a main time entry menu 500 of a system for tracking time entries, according to an embodiment of the present invention. The time entry menu 500 of the time entry tool 130 may include various functions and services, such as an enter time function 510, a view posted time function 512, a helper spreadsheet function 514, a reports function 516, a RFS homepage function 518, a help function 520, a feedback/support function 522 and other functions 524.

The enter time function 510 enables an authorized user to enter time for a specific task, project or other category of work-related duties. The view posted time function 512 enables a user to view all of the time posted for a defined time period where the time posted may be categorized based on various factors. The helper spreadsheet function 514 provides a tool to record time prior to data entry where user specific time entry categories may be displayed. Some users may find this tool helpful when initiating the process of tracking time through the present invention. The reports function 516 enables an authorized user to generate, view and analyze reports for different business units which may be applied across various users, teams, and other sectors. The RFS homepage function 518 may enable a RFS and other tasks to be entered, updated and modified. The help function 520 provides instructions for time entry, frequently asked questions, links to other web pages and resources and other data. The feedback function 522 enables a user to provide concerns, questions and other forms of feedback and other relevant data to the system of the present invention.

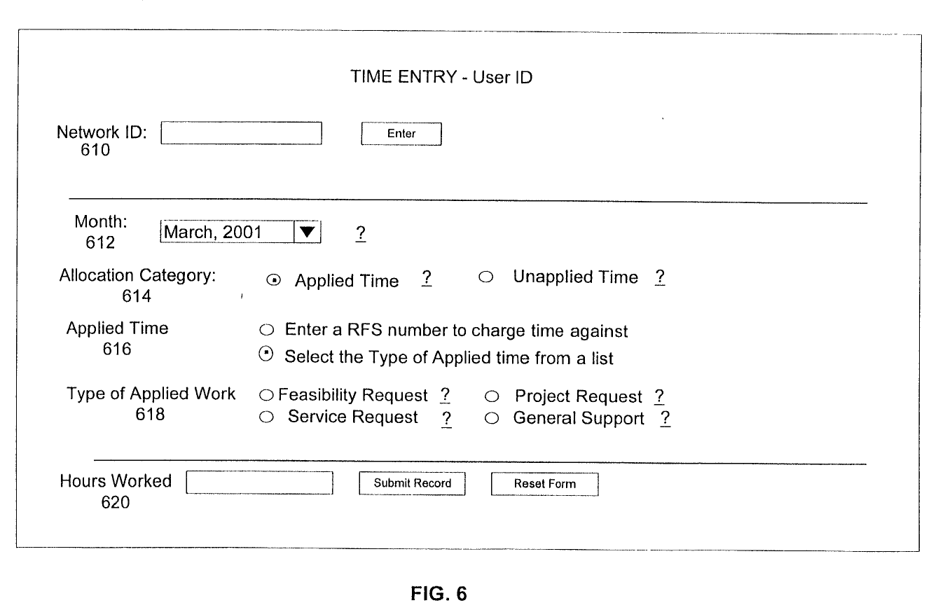

FIG. 6 is an example of a time entry screen shot, according to an embodiment of the present invention. By accessing the system of the present invention, a user may enter a network ID at a network ID input section 61 0 to verify authorization to access the system. A time period, such as a month, may be selected for time entry at a month drop down menu 615. Other time periods may be selected as well, such as a day, a week, a month, or another user-defined time period. The user may then input in an allocation category input section 614 whether the time entry should be included in the applied time category or in the unapplied time category. If the applied time category is selected, the user may specify a further subcategory at an applied time section 616. For example, the user may enter a RFS number (or other identifier) and select the applied time category for the time entry. At a type of applied work section 618, a user may specify the type of applied work, which may include work relating to a feasibility request, a project request, a service request, general support and other categories of applied work. The user may then enter the number of hours for the selected type of work at an hours worked section 620. Each time record may be entered and submitted individually. The user may be brought back to the time entry screen for additional time record entry.

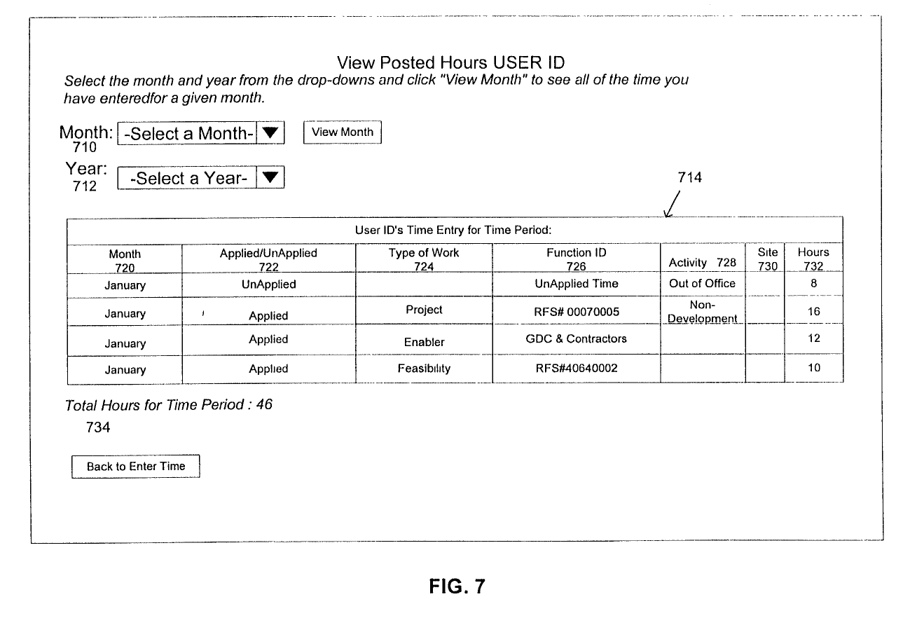

FIG. 7 is an example of a view posted hours screen shot, according to an embodiment of the present invention. After time records have been posted and entered for a predetermined period of time, a user may view the posted time entries. The user may select a time period for which to view the posted time entries. For example, the user may select a month at a “Select a Month” drop down menu 710, and a year at a “Select a Year” drop down menu 712. Other time periods may be identified. A time entry chart 714 may display a user's posted time entries, which may be further broken down by various categories. For example, the time entry chart 714 may include a time period column 720, which may display the selected time period, such as a month; an applied/unapplied column 722, a type of work column 724, a function id column 726, an activity column 728, a site column 730, and an hours column 732. Other categories may also be identified and implemented, based on varying business needs, level of detail required and other factors. The total number of hours posted for the selected time period may be displayed at a total hours for time period section 734. This screen enables a user to view all time entries posted for a selected time period, such as a month. The time entry chart 714 further enables a user to categorize time entries based on various criteria. Other sorting, calculating and analyzing functions may be performed.

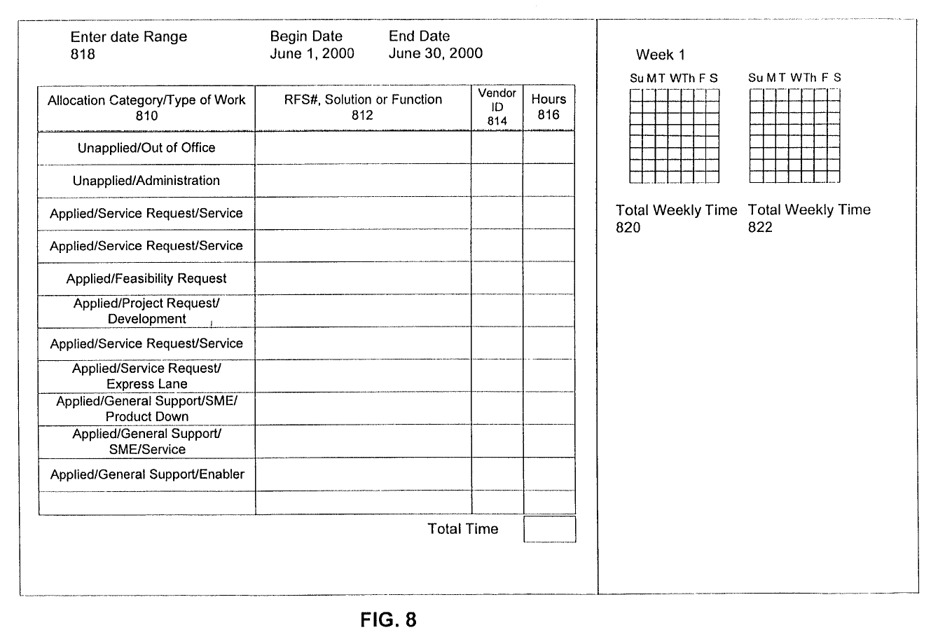

FIG. 8 is an example of a helper spreadsheet, according to an embodiment of the present invention. The helper spreadsheet provides a detailed breakdown of the time entries for a selected user. A user selected date range may be entered at an “Enter Date Range” section 818. An “Allocation Category/Type of Work” column 810 may provide a plurality of allocation categories (or types of work) applicable to the user's time entries. A “RFS #, Solution or Function” column 812 may provide an associated RFS number, a solution or a function that may be associated with the allocation category, if applicable. A column 814 may provide Vendor ID which may be used to identify requests submitted to a vendor. Associated hours may be listed under an hours column 816. Weekly time totals may be displayed in a first total weekly time section 820 and a second total weekly time section 822. This view provides a detailed breakdown of hours.

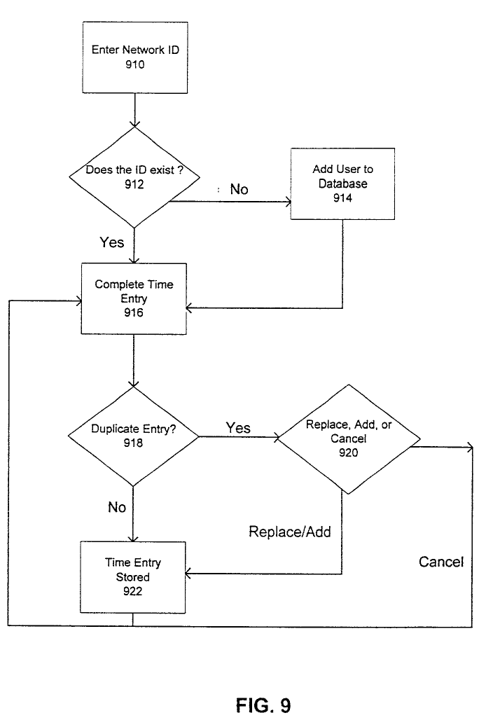

FIG. 9 is a flowchart illustrating the steps performed in a user decision process using the system described herein, according to an embodiment of the present invention. At step 910, a user may enter a network identifier (ID) to obtain access to the system. Additional security features may be implemented, such as a password or another security mechanism. At step 912, the system determines whether the entered network ID is valid and/or that the user is otherwise authorized to access the system. For example, the system may check whether the network ID exists in a user database. If the network ID does not exist in the user database, the user may be added to the user database, at step 914. If the user is an authorized user, the user may enter one or more time entries at step 916. The system may then determine whether the entered time entry is a duplicate time entry. This may be accomplished by comparing the entered time entry data to previously entered time entry data entered into the system by the same user. If the entered time entry is determined to be a duplicate time entry, the user may replace, add, or cancel the entered time entry at step 920. If the user decides to replace an entered time entry or add an entered time entry, the replaced or added entered time entry may be stored at step 922. If the user decides to cancel an entered time entry, the cancelled time entry may be closed, at step 916, without saving the time entry.

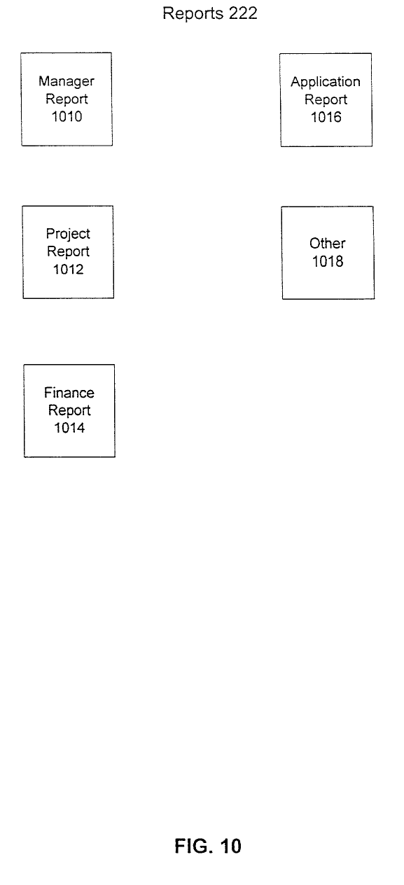

FIG. 10 is an example of a reports module 222 according to an embodiment of the present invention. The reports module 222 may include a manager report 1010, a project report 1012, a finance report 1014, an application report 1016 and another report 1018. A user or other authorized time entering entity may access the reports module 222 to run various reports for a business need or purpose. For example, an analysis may be made for purposes related to management, projects, finances, applications and other areas of interest. Time entry reports may be viewed by site, across selected sites, across all sites and/or based upon other selected criteria.

A manager or another authorized time entering entity may access the manager report 1010 to view time entries posted by a selected team. A project leader or other authorized time entering entity may access the project report 1012 to view time entries related to an identified project or a general support area. A finance leader or other authorized time entering entity may access the finance report 1014 to collect information for inter-company billing and capitalization. An application leader or other authorized time entering entity may access the application report 1016 to provide time tracking details regarding a selected application and/or solution.

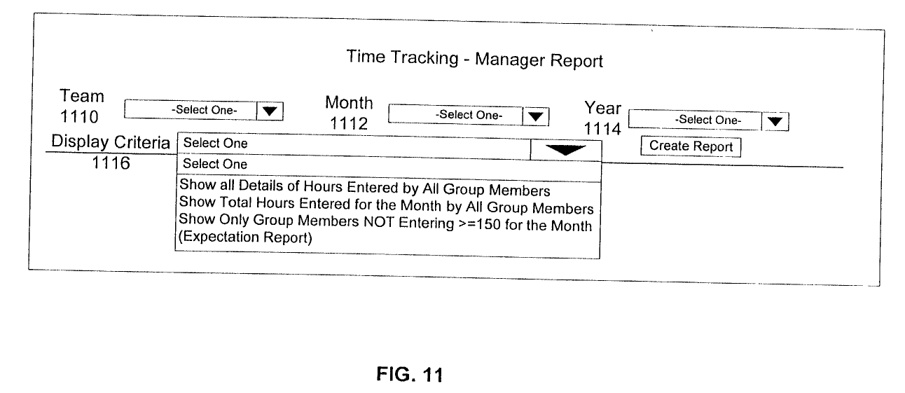

FIG. 11 is an example of a manager report 1010 screen shot, according to an embodiment of the present invention. An authorized time entering entity may access the manager report 1010 to view, customize and analyze time entries related to a selected team. A team, such as an IT team, may be selected at a “Team” drop down menu 1110. A time period for tracking time entries may be selected via a month drop down menu 1112 and a year drop down menu 1114. A display criteria may be selected at a display criteria drop down menu 1116. The display criteria may include details of hours entered by group members (some, selected, all, etc.), total hours entered for a time period (e.g., day, week, month, quarter, year, user defined, etc.), group members having time entries below or above a predetermined threshold (e.g., entering at least 150 hours a month which may be used to verify that users are recording their time), and other similar display criteria. In addition, user defined display criteria may be specified for detailed analysis. The manager report 1010 may be generated for further analysis and a detailed examination.

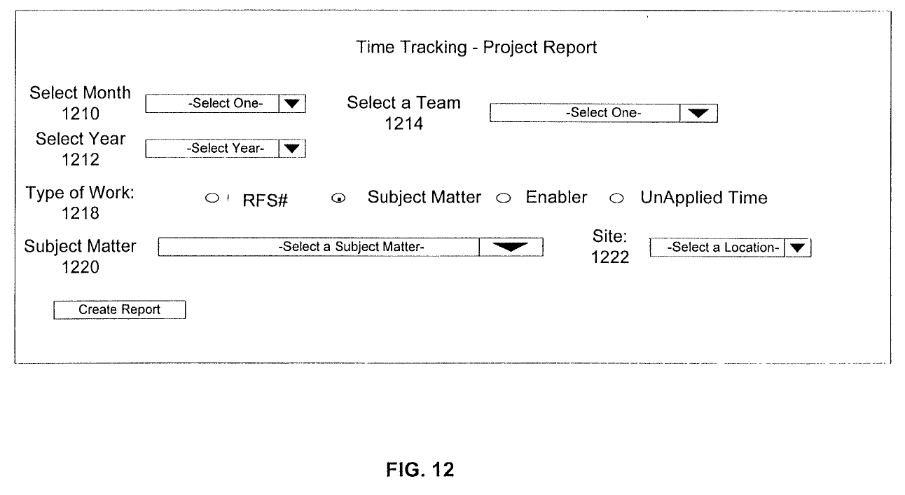

FIG. 12 is an example of a project report 1012 screen shot according to an embodiment of the present invention. The project report 1012 enables an authorized user to customize time tracking data details for a particular type of work. An authorized user may select a time period via a month drop down menu 1210 and a year drop down menu 1212. A team of interest (e.g., the IT team) may be selected at a “Select a Team” drop down menu 1214. The type of work may be identified at a “Type of Work” drop down menu 1218, which may include categorizing work by a RFS number, subject matter, an enabling function or in the unapplied time category. Other categories may be selected as well. If the type of work is categorized by subject matter, for example, the subject matter may be selected at a Subject Matter drop down menu 1220. A site location may also be selected at a Site drop down menu 1222.

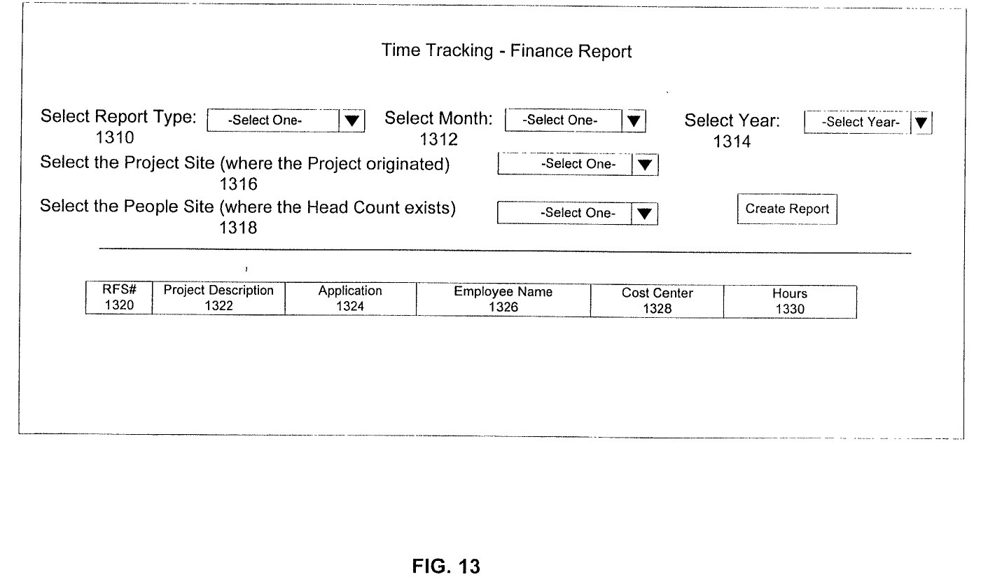

FIG. 13 is an example of a finance report 1014 screen shot, according to an embodiment of the present invention. The finance report 1014 may enable an authorized user to customize finance data for analysis and inter-company billing, for example. The authorized user may select a report type at a “Select Report Type” drop down menu 1310, which may include capitalization projects, intercompany billing and other options. A time period of interest may be selected via a month drop down menu 1312 and a year drop down menu 1314. Other user defined time periods may be used. A project site where a project originated may be selected at a “Select the Project Site” drop down menu 1316. A people site may also be selected at a “Select the People Site” drop down menu 1318. The Select the People Site drop down menu 1318 is used to select a location where the head count exists. The count of heads may be the number of individual salaries being charged to a budget account. Information in a finance report 1014 may include a RFS identifier 1320, a project description 1322, an application 1324, an employee name (or other identifier) 1326, a cost center 1328, an hours amount 1330 and/or other similar information.

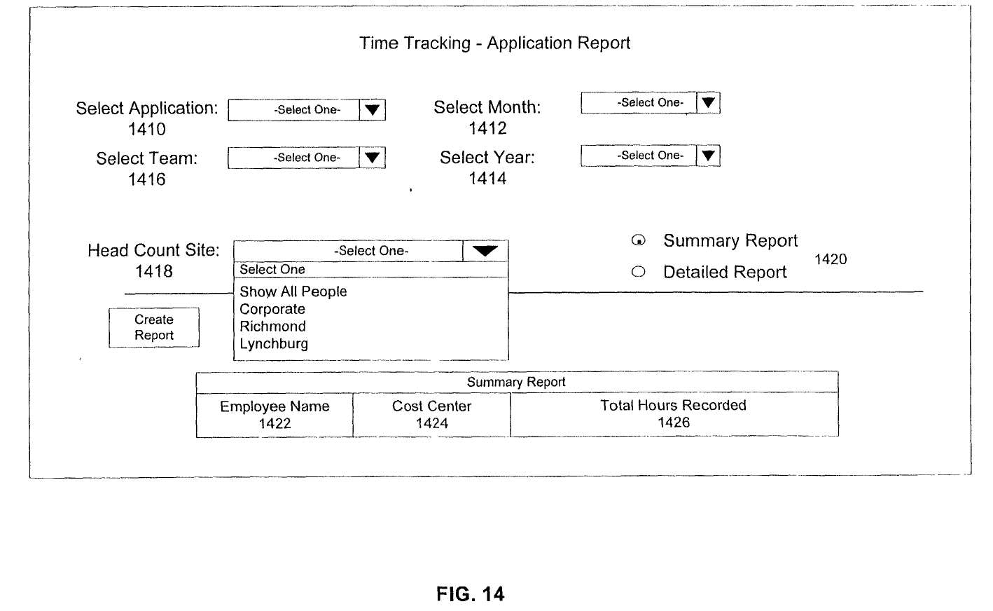

FIG. 14 is an example of an application report 1016 screen shot, according to an embodiment of the present invention. The application report 1016 may enable an authorized user to customize data for a specific application. The authorized user may select an application at a Select Application drop down menu 1410. A team of interest (e.g., an IT team) may be selected at a “Select Team” drop down menu 1416. A desired time period may be selected via a month drop down menu 1412 and a year drop down menu 1414. A head count site may be selected at a “Select Head Count Site” drop down menu 1418. The head count site drop down menu 1418 may include options, such as a show people option (e.g., some, selected, all, etc.), a division option (e.g., corporate), a geographic location option (e.g., city, state, region, continent, etc.) and/or another location option. A generated application report 1016 may include a summary report, a detailed report, or another type of report, as shown by a radio button 1420. A summary report may include information such as an employee name (or identifier) 1422, a cost center 1424, a total hours recorded 1426 and/or other information.

Various components of the system 100 and method of the present invention have been described. It should be appreciated that a user device for the users 110 and 112 may include a personal computer running a Microsoft® Windows® 95 operating system, a Microsoft® Windows® 98 operating system, a Millenium™ operating system, a Microsoft Windows NT™ operating system, an XP™ operating system, a WindowS™CE™ operating system, a PalmOS™ operating system, a Unix operating system, a Linux operating system, a Solaris™ operating system, an OS/2™ operating system, a BeOS™ operating system, a MacOS™ operating system, a VAX VMS operating system or another operating system or platform. The personal computers associated with the users 110 and 112 may also include a microprocessor such as an Intel x86-based device, an Advanced Micro Devices x86-compatible device, a Motorola 68K device, a PowerPC™ device, a MIPS device, a Hewlett-Packard Precision™ device, a Digital Equipment Corporation Alpha™ RISC processor, a microcontroller or another general or special purpose device operating under programmed control. The system 100 of the invention may also include an electronic memory such as a random access memory (RAM), an electronically programmable read only memory (EPROM), a storage device such as a hard drive, a CDROM or a rewritable CDROM or another magnetic or optical device media. The system may further include other associated components connected over an electronic bus, as will be appreciated by persons skilled in the art. The system 100 may also include a network-enabled appliance such as a WebTV™ unit, a radio-enabled Palm™ Pilot, a set-top box, a networkable game-playing console such as a Sony Playstation™ console or a Sega Dreamcast™ console, a browser-equipped or another network-enabled cellular telephone, or another TCP/IP client or other device.

The databases of the system 100 may include or interface to, for example, an Oracle™ relational database such as that sold commercially by Oracle Corporation, an Informix™ database, a Database 2 (DB2) database, a Sybase database or another database or data storage device utilizing a query format, a platform or a resource such as an On Line Analytical Processing (OLAP) format, a Standard Query Language (SQL) format, a storage area network (SAN) format, a Microsoft Access™ format or others.

A communications link for the system 100 may be comprised of, include or interface to any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, V.34 or V.34bis analog modem connection, a cable modem, an Asynchronous Transfer Mode (ATM) connection, a Fiber Distributed Data Interface (FDDI) connection or a Copper Distributed Data Interface (CDDI) connection. The communications link may also include or interface to any one or more of a Wireless Application Protocol (WAP) link, a General Packet Radio Service (GPRS) link, a Global System for Mobile Communication (GSM) link, a Code Division Multiple Access (CDMA) link, a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth link, a WhiteTooth radio link, or an IEEE 802.11 (or Wi-Fi)-based radio frequency link. The communications link may further include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

As is clear from the Detailed Description, the system and method of the present invention provides an easy, user-friendly, efficient means for capturing and reporting resource utilization and allocation of resources, finances and other relevant data.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for capturing and reporting utilization and allocation of resources and finances comprising the steps of:
identifying at least one of business needs, goals, and requirements;
categorizing at least one work task into one or more categories wherein the categories include an applied time category and an unapplied time category;
authorizing at least one time entering entity to report time associated with the categories;
storing time entry data from the time entering entity; and
generating reports for analyzing the time entry data based on one or more user defined factors.

2. The method of claim 1 wherein the applied time category includes at least one service request and wherein an authorized service requesting entity submits the at least one service request.

3. The method of claim 2 further comprising the step of assigning a request for service identifier to each one of one or more work requests.

4. The method of claim 3 wherein the work request includes one or more of a feasibility request, a project request, and a service request.

5. The method of claim 1 wherein the applied time category includes a general support category and wherein the general support category further includes at least one of a solution and an enabling function.

6. The method of claim 1 wherein the unapplied time category includes at least one of a plurality of out-of-office tasks and a plurality of administrative tasks.

7. The method of claim 1 wherein the generated reports include one or more of a manager report, a project report, a finance report, and an application report.

8. The method of claim 1 wherein the step of authorizing at least one time entering entity further comprises a step of authorizing a level of access.

9. The method of claim 1 wherein the step of authorizing at least one time entering entity further comprises a step of authorizing a group of users.

10. The method of claim 1 wherein the time entry data includes one or more of a user identifier, a time estimate, a project data, a solution data, a function data, a request for service identifier, and a site location.

11. A system for capturing and reporting utilization and allocation of resources and finances comprising:
identifying means for identifying at least one of business needs, goals, and requirements;
categorizing means for categorizing at least one work task into one or more categories wherein the categories include an applied time category and an unapplied time category;
authorization means for authorizing at least one time entering entity to report time associated with the categories;
storing means for storing time entry data from the time entering entity; and
generating means for generating reports for analyzing the time entry data based on one or more user defined factors.

12. The system of claim 11 wherein the applied time includes at least one service request and wherein an authorized service requesting entity submits the at least one service request.

13. The system of claim 12 further comprising assigning means for assigning a request for service identifier to one or more work requests.

14. The system of claim 13 wherein the work request includes one or more of a feasibility request, a project request, and a service request.

15. The system of claim 11 wherein the applied time includes at least a general support category and wherein the general support category further includes at least one of a solution and an enabling function.

16. The system of claim 11 wherein the unapplied time category includes at least one of a plurality of out-of-office tasks and a plurality of administrative tasks.

17. The system of claim 11 wherein the generated reports include one or more of a manager report, a project report, a finance report, and an application report.

18. The system of claim 11 wherein the step of authorizing at least one time entering entity further comprises a step of authorizing a level of access.

19. The system of claim 11 wherein the step of authorizing at least one time entering entity further comprises a step of authorizing a group of users.

20. The system of claim 11 wherein the time entry data includes one or more of a user identifier, a time estimate, a project data, a solution data, a function data, a request for service identifier, and a site location.
